(19) United States
(12) Patent Application Publication
(10) Pub. No.: US 2025/0222697 A1
(43) Pub. Date: Jul. 10, 2025

(54) Method and Device for Determining a State of a Filter Unit in an Ink Circuit of a Printer

(71) Applicant: Canon Production Printing Holding B.V., Venlo (NL)

(72) Inventors: Jochen Reinders, Isen (DE); Amirmasoud Pourmoosa Abkenar, Poing (DE)

(21) Appl. No.: 19/014,393

(22) Filed: Jan. 9, 2025

(30) Foreign Application Priority Data
Jan. 10, 2024 (DE) 10 2024 100 633.1

(51) Int. Cl. B41J 2/175

(52) U.S. Cl. CPC B41J 2/17566; B41J 2/17563; B41J 2/17596

(57) ABSTRACT

A method and a device for determining a state of a filter unit in an ink circuit of a printer is provided. Ink is pumped from an ink reservoir, through the filter unit, into an ink container, starting from an initial fill level of the ink container, until the first fill level value in the ink container is reached, so that at least a predetermined volume between the initial fill level and the first fill level value is filled. The time of the activated ink pump until the first fill level value is reached is detected. The volumetric flow of the ink through the filter unit is determined based on the predetermined volume and the detected time. The determined volumetric flow is compared with a volumetric flow limit value. A filter state information is generated upon reaching or falling below the volumetric flow limit value.

### CROSS-REFERENCE TO RELATED APPLICATION

This application claims priority to German Patent Application No. 10 2024 100 633.1 filed Jan. 10, 2024, the disclosure of which is hereby incorporated by reference in its entirety.

### BACKGROUND

### Field of the Disclosure

The invention relates to a method and a device for determining a state of a filter unit in an ink circuit of a printer. Starting from an initial fill level of an ink container, with the aid of an ink pump ink is pumped from an ink reservoir, through the filter unit, into the ink container. At least one first fill level value in the ink container is detected with the aid of a sensor unit, wherein the initial fill level is below the first fill level value. With the aid of the ink pump, ink is pumped into the ink container until the first fill level value is reached, so that at least a predetermined volume between the initial fill level and the first fill level value is filled.

### Description of Related Art

Given high-capacity inkjet printers with print speeds of greater than 1 m/s, up to presently 3 m/s, filter units for filtering the ink are used in order to remove unwanted suspended substances and/or solids from the ink before this is supplied to the print heads of the printer. Without an efficient filter unit, these suspended substances and/or solids would clog the nozzles of the print head and negatively affect the print quality. The filters of the filter unit of a printer are consumables and must be exchanged if they become fouled. A printing device with a filter unit is known from the document DE 10 2020 129 787 A1, for example.

The document EP 3 335 884 A1 discloses an ink supply system with a counter that counts the printed ink droplets and, based on the number of printed ink droplets, determines a printed ink volume and a delivery rate of an ink pump.

Depending on the state and quality of the ink, filter units in high-capacity printers are often clogged. They then cause sudden downtimes of the printer and require unplanned service assignments of service technicians, only in order to swap the filter of the filter unit. This is a complicated and costly process. Long downtimes of the printer can also be caused by this.

In order to avoid this, all filters can be proactively exchanged if only one filter is clogged. Alternatively or additionally, it is also conceivable that all filters of the printer, or of all printers of a client, are exchanged proactively after a predetermined time and/or predetermined operating hours and/or predetermined ink consumed quantity, independently of the state of the filters. The filters of a printer can thus be exchanged every month, independently of the actual fouling of the filter.

Although the proactive changing of the filters solves the problem of sudden downtimes of the printer, it is not resource- efficient and is expensive.

### SUMMARY

The object of the invention is to provide a method and device for determining a state of a filter unit in an ink circuit of a printer.

This object is achieved via a method having the features described herein and via a device having the features described herein.

Via the method having the features described herein, the state of fouling of the filter unit can be determined simply before the filter unit is so fouled, or so clogged with dust particles, that sufficient ink can no longer be pumped through the filter unit. Via the method, a proactive exchange of the filters of the printer is not necessary, but failures of the printer due to clogged filters are also prevented in that timely information about the fouling of the filter can be obtained and an exchange of the filter can be initiated in a timely manner, and not prematurely. In particular, the filter unit has a swappable filter. The determined filter information can be output in particular in order to inform an operator or a service technician about the filter state, in particular about a necessary filter change.

It is advantageous if the ink container is empty in its initial fill state. Alternatively or additionally, the sensor unit can detect a second fill level value, and the initial fill level corresponds to the second fill level value. The initial fill level can hereby be determined simply and reliably.

The initial fill level of the ink container can also be achieved in that ink is pumped out of the ink container with the aid of the ink pump or an additional ink pump. The initial fill level can hereby be achieved simply, even if a higher fill level in the ink container is present due to the process.

It is especially advantageous if the ink pump is driven with a control voltage so that a pump rotor to drive the pump is pre-tensioned at rest, and the pump rotor drives the ink pump with a nominal rotation speed given a sudden increase in the control voltage, and ink is thereby pumped at a constant delivery rate with the aid of the ink pump. The nominal rotation speed of the ink pump can hereby be achieved more rapidly, so that the nominal delivery rate of the ink pump is achieved relatively quickly. Alternatively, after the activation of the ink pump, the rotation speed of an electric drive of the ink pump can be increased along an acceleration ramp up to the nominal rotation speed, wherein reduced volumetric flow due to the ramping-up of the ink pump can hereby be determined and simply be taken into account in the determination of the volumetric flow through the filter unit. The accuracy in determining the volumetric flow through the filter unit is hereby increased.

It is particularly advantageous if the ink pump is an electrically driven gear pump. An exact and constant delivery rate is hereby achieved. Gear pumps are also cost-effective and low-maintenance.

It is also advantageous if the method is implemented in a printing pause and/or every 1 to 2 days and/or every 24 to 48 operating hours. The filter state is hereby determined sufficiently often to initiate a filter change given a fouled filter.

It is also advantageous if a value within a range of 60% to 80% of the volumetric flow with a new filter is preset as a limit value. A sufficient remaining volumetric flow for the further printing operation is hereby ensured.

In particular, a warning message can be output, preferably to a service center, if a value exceeds or falls below the limit value. It is hereby ensured that a filter change can be initiated simply.

A printer to execute the method in particular comprises at least one ink pump to pump ink; an ink container to provide ink for print heads of the printer; and an ink reservoir to provide ink; and at least one filter unit to filter the ink. Ink is supplied to the printer with the aid of the ink reservoir, wherein a full ink reservoir is inserted into the printer for this purpose. After the ink has been pumped out of the ink reservoir with the aid of the ink pump, the empty ink reservoir is removed again from the printer and an additional full ink reservoir is inserted into the printer.

Furthermore, the printer can comprise at least one sensor unit that is designed to detect at least one first fill level value in the ink container.

The device having the features of the parallel device claim has the same advantages as the claimed method. In particular, the device can be developed with the features of the dependent claims directed toward the method, and the aforementioned developments.

### BRIEF DESCRIPTION OF THE DRAWINGS

The terms Fig., Figs., Figure, and Figures are used interchangeably in the specification to refer to the corresponding figures in the drawings.

Exemplary embodiments of the invention are explained in detail in the following using the schematic drawings. Shown therein are:

FIG. 1 a schematic plan view of a printing device,

FIG. 2 a block diagram of an arrangement for determining a state of a filter unit in the ink circuit of the printing device,

FIG. 3 a workflow diagram to determine a state of a filter unit in the ink circuit, and

FIG. 4 a diagram in which is depicted an example of a curve of the volumetric flow through the filter unit, depending on the operating time of the printing device.

The non-limiting embodiments of the present invention will be described with reference to the accompanying drawings. Elements, features and components that are identical, functionally identical and have the same effect are, insofar as is not stated otherwise, respectively provided with the same reference character.

### DESCRIPTION OF THE INVENTION

In the following description, numerous specific details are set forth in order to provide a thorough understanding of the embodiments of the present invention. However, it will be apparent to those skilled in the art that the embodiments, including structures, systems, and methods, may be practiced without these specific details. Well-known methods, procedures, components, and circuitry have not been described in detail to avoid unnecessarily obscuring embodiments of the invention. The connections shown in the figures between functional units or other elements can also be implemented as indirect connections, wherein a connection can be wireless or wired. Functional units can be implemented as hardware, software or a combination of hardware and software.

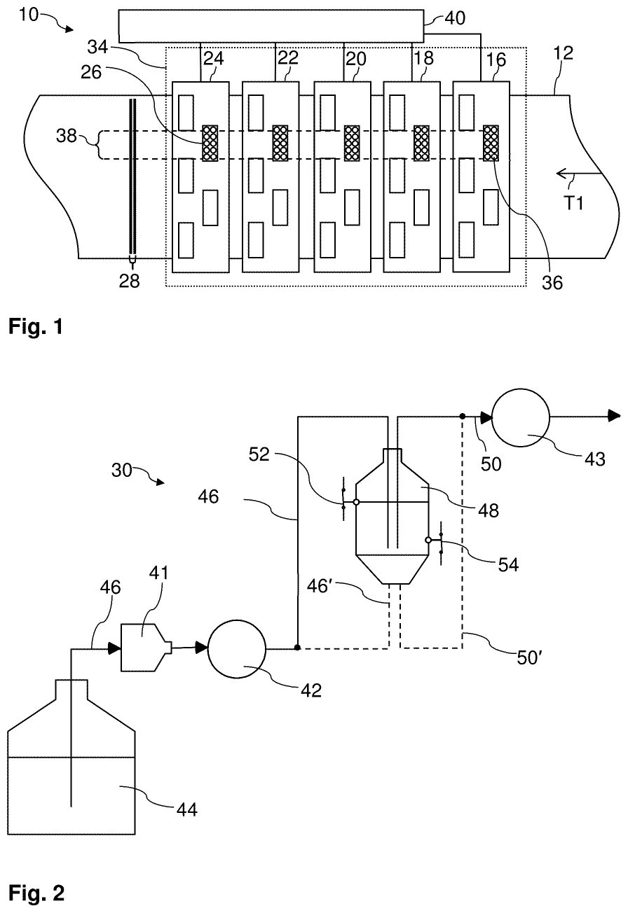

FIG. 1 shows a schematic plan view of a printing device 10 for printing to a recording medium 12 in the form of a web. In the exemplary embodiment, the printing device 10 is executed as a known inkjet printing device. Such a printing device is known from the document DE 10 2014 106 424 A1, for example. The printing device 10 is also generally referred to in this application as a printer 10.

The printing device 10 has, per primary color, at least one print bar 18 to 24 having one or more depicted print heads 26 that are arranged transverse to a transport direction T1 of the continuously drivable recording medium 12, here in the form of a web. The recording medium 12 can be made of paper, paperboard, cardboard, textile, a combination of these, and/or other media that are suitable and can be printed to.

As an alternative to continuously fed recording media 12 in the form of a web, individual sheets can also be supplied to the printing device 10.

The recording medium is guided through the printing device 10 and—with the aid of a plurality of guide rollers—is thereby directed past the print bars 16 through 24 having at least one print head 26, wherein the print heads 26 apply a print image 28 in the form of dots onto the recording medium 12. In FIG. 1, the print image 28 is presented by way of example as two parallel bars printed across the printable width of the recording medium 12.

The recording medium 12 is subsequently guided further to a drying (not shown), and if applicable to a subsequent additional printing device in which in particular the back side of the recording medium 12 can then be printed to. Subsequent or as an alternative to this, the recording medium 12 can be supplied to a post-processing in which the recording medium 12 is cut, folded, and/or finished in other work steps.

For full-color printing, four primary colors are typically used, namely CMYK (cyan, magenta, yellow, and key (black)). Additional primary colors, for example green, orange, or violet, can expand the color range of the printing device 10. Moreover, still more colors or special inks can be present, such as MICR ink ((Magnetic Ink Character Recognition=magnetically readable ink). Each primary color is printed onto the recording medium 12 with the print heads 26 of a single print bar 18 through 24. It is similarly possible that transparent special fluids, such as primer or drying promoter, are applied digitally before or after the printing of the print image 28, likewise with the aid of a separate print bar, in order to improve the print quality or the adhesion of the ink on the recording medium 12. In the exemplary embodiment according to FIG. 1, a primer fluid is printed onto the recording medium 12 with the aid of the print bar 16. The primer fluid is thus printed onto the recording medium 12 before the printing of the print image 28.

The print bars 16 to 24 form a printing unit 34. Each of the print bars 16 to 24 of the printing device 10 can print the full line width. For this purpose, each print bar 16 to 24 comprises a plurality of print heads 26 that are arranged side by side, offset into two rows.

In FIG. 1, each print bar 16 to 24 comprises five print heads 26 in order to apply the print image 28 onto the recording medium 12 in a plurality of columns 38. Each print head 26 comprises a plurality of print nozzles 36 (for simplification, only ten print nozzles are depicted in FIG. 1), wherein each print nozzle 36 can apply ink droplets of a variable volume onto the recording medium 12 in the form of dots. In practice, each print head 26 can comprise multiple hundreds to multiple thousands of print nozzles 36 directed toward the recording medium 12. The print nozzles 36 are arranged in a row transverse to the transport direction T1. With the aid of the print nozzles 36 of a print head 26, a print image 28 can be printed over a portion of a line along the printable width of the recording medium 12 and, in the form of one of the columns 38, over the length of the recording medium 12 in the transport direction T1. A region of the recording medium 12 below the print head 26 is thereby printed to by every print head 26.

In other embodiments, each print head 26 has a plurality of rows of print nozzles 36. In this instance, a region having a plurality of lines is printed onto the recording medium 12 simultaneously below the print head 26.

Each dot along a line over the printable width of the recording medium 12 is printed by the corresponding print nozzle 36 of the print bar 18 to 24. The print resolution in the print line direction (transverse to the transport direction T1) is thus determined by the pitches of the dots printed by the print nozzles 36 onto the recording medium 12. By contrast, given individual print heads the print resolution in the transport direction T1 is determined by the transport velocity of the recording medium 12, and given line-clocked printing by the line timing of the print bars 16 to 24. Given a plurality of print nozzle rows, the print resolution in the transport direction T1 is dependent on the pitch of the print nozzle rows relative to one another.

Given the printing device 10 according to FIG. 1, the print bars 16 through 24 are arranged stationary. In other embodiments, the print bars 16 to 24 can also preferably be arranged so as to be movable transverse to the transport direction T1.

With the aid of a control unit 40, the individual print heads 26 of the print bars 18 to 24 are activated, based on rastered print data, so that the individual ink droplets are applied at the position of the recording medium 12 that has been defined by the print data. The individual ink droplets form individual dots on the recording medium 12, which dots form in their entirety the print image 28 on the recording medium 12. In an exemplary embodiment, the control unit 40 includes processing circuitry or at least one processor that is configured to perform one or more functions and/or operations of the control unit 40, including activating the individual print heads 26 of the print bars 18 to 24 to apply the print image onto the recording medium 12 based on print data, processing print and/or other data, control one or more modes of the printing device 10 and/or controlling one or more operations of the printing device 10. In an exemplary embodiment, the control unit 40 includes one or more interfaces (e.g. a wired and/or wireless input and/or output interface, transceiver, or the like) that are configured to receive or output data or information. For example, the control unit 40 may receive signals generated by one or more components of the printing device 10 (e.g. from a user interface of the printing device 10) and/or output control signals to one or more components of the printing device 10. In an exemplary embodiment, the control unit 40 includes a memory configured to store data/information, and/or store executable code that is executable by the processing circuitry or at least one processor to cause the processing circuitry or at least one processor to perform the operation(s) of the control unit 40.

The area coverage of the dots in a region of the recording medium 12 determines the inking intensity in this region. Given complete inking of the recording medium 12 with a primary color, the inking intensity is 100%. Given half-inking of the recording medium 12, the inking intensity is 50%. In the event that no inking of the recording medium 12 takes place in the region, the inking intensity amounts to 0%.

FIG. 2 shows a block diagram of an arrangement 30 for determining a state of a filter unit 41 in the ink circuit of the printing device 10. An ink pump 42 conveys ink from an ink reservoir 44, via an ink line 46 through the filter unit 41, into an ink container 48. The ink pump 42 is a hose pump, peristaltic pump, and/or gear pump, for example, wherein the pumps respectively preferably have a brushless DC drive with a signal output for a tachometer signal. This tachometer signal can then contain at least one pulse per rotation.

The filter unit 41 removes unwanted suspended substances and/or solids from the ink. The filter unit 41 in particular comprises a filter that can be exchanged for a new filter if it becomes fouled.

One of the print bars 18 to 24 is supplied with ink, or the ink is transported to one of the print bars 18 to 24, via a print bar ink line 50, in order to then be printed onto the recording medium 12. The printing device 10 comprises at least four of the arrangements 30 that respectively supply a print bar 18 to 24 with ink. An arrangement 30 is thus provided for each of the primary colors CMYK.

Furthermore, with the aid of an additional arrangement 30, the primer print bar 16 can be supplied with a primer fluid. In this instance, the primer fluid is conveyed by the ink pump 42 instead of ink. If ink is discussed in the specification in the context of the arrangement 30, the term also encompasses the primer fluid.

Furthermore, the ink pump 42 in particular comprises what is known as a BLDC drive that can be activated via the control unit 40 of the printing device 10 in order to pump ink. With the aid of a rotation sensor (tachometer), the control unit 40 can thereby determine the driven rotation speed of the drive of the ink pump. The rotation sensor is, for example, a Hall effect sensor that generates at least one pulse per rotation of a drive shaft and, given multiple pulses per rotation, can even determine a fraction of a rotation. The ink pump 42 can furthermore be activated with a control voltage so that a magnetic field is built up in the electrical pump drive and the ink pump is already preloaded, without the drive shaft moving. The preloading overcomes the existing mechanical play in the pump in order to avoid further inaccuracies. Upon starting a pump, the control voltage is then suddenly raised corresponding to a nominal rotation speed in order to bring the drive shaft to said nominal rotation speed. Due to the preloaded pump drive, the drive shaft can be accelerated to its nominal rotation speed with a starkly shortened acceleration phase. Fluctuations in the delivery efficiency in the run-up of the ink pump 42 can thus be reduced.

The ink container 48 of the arrangement 10 comprises at least one sensor unit having a first signal emitter 52 and a second signal emitter 54. The sensor unit detects a fill level of the ink container 48. The first signal emitter 52 detects a first fill level value if ink in the ink container 48 reaches at least the first signal emitter 52. In FIG. 2, the ink container 48 is shown so filled with ink that the ink has reached the first signal emitter 52, and thus determines a first fill level value. Corresponding to this, the second signal emitter 54 determines a second fill level value that lies below the first fill level value.

The ink volume of the ink container 48 between the first fill level value and second fill level value is predetermined. That means that a predetermined volume is located between the first fill level value and the second fill level value. The ink container 48 is precisely manufactured, and the sensor unit is precisely arranged, so that the corresponding volume can be very precisely calculated via the various ink containers.

Alternatively, the sensor unit of the ink container 48 can comprise only one signal emitter that either determines only one fill level value or determines the continuous fill level value of an arbitrary fill value within a sensor range. For example, the sensor unit can be an ultrasound sensor.

The control unit 40 is designed to determine the turn-on time of the pump 42 for pumping ink into the ink container 48 that is necessary, starting from the second fill level value, until the first fill level value is reached.

The control unit 40 determines the volumetric flow through the filter unit 41 based on the determined turn-on time and the predetermined volume. The volumetric flow is in particular dependent on the filter state, i.e. on the fouling state, of the filter unit 41. The determined volumetric flow is compared with a preset stored limit value. If the determined volumetric flow reaches and/or falls below the limit value, a defined degree of fouling has been reached. A filter state information, via which an exchange of the filter can be initiated in good time, can hereby already be determined before a degradation of the ink supply to the ink container 48. A preventative exchange of the filter is thus no longer necessary, whereby resources and thus costs can be saved.

In other embodiments, a degassing unit can also be provided before and/or after the filter unit 41. Such a degassing unit removes gas inclusions from the ink, in particular air bubbles and/or gases dissolved in the ink.

Furthermore, in alternative embodiments a heat exchanger can be provided in the ink line 46, with the aid of which the temperature of the ink can be adapted or regulated. The filter unit 41 can also be arranged after the pump 42, in the ink line 46.

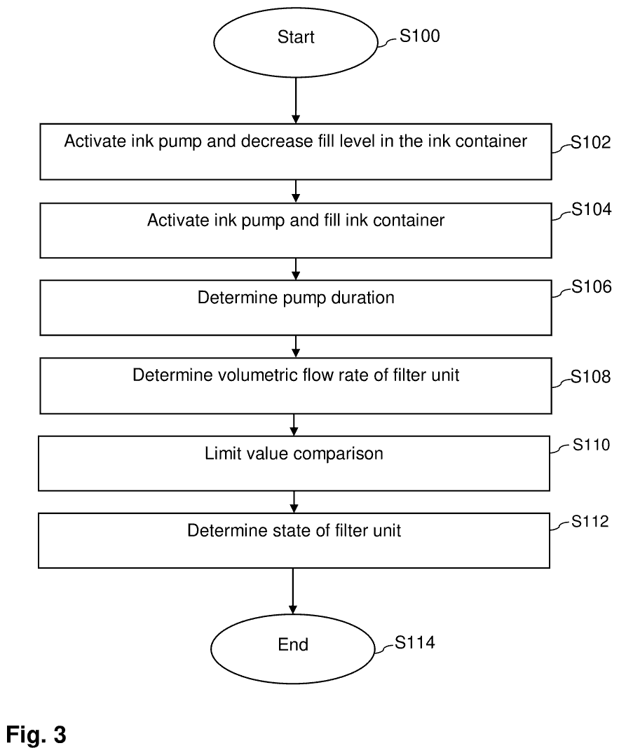

FIG. 3 shows a workflow diagram for determining a state of the filter unit 41 in the ink circuit or in the ink line 46. The method starts in step S100. In step S102, the ink pump 42, and/or the ink pump 43 arranged in line 50, is activated in order to decrease the fill level in the ink container 48 below the second fill level value, insofar as such is present. If the second signal emitter 54 is not present or is not in use, the ink container 48 can be entirely emptied. In this instance, the ink intake 46′ and/or ink drain 50′ can preferably be arranged at the lowermost point of the ink container 48 (see conduits 46′, 50′ shown in dashed lines). The ink pump 42 and/or 43 is thereby activated by the control unit 40 so that ink is pumped from the ink container 48 into the ink reservoir 44. If the control unit 40 detects the second fill level value with the aid of the second signal emitter 54, the ink pump 42 (and/or 43) is stopped upon pumping dry if the second fill level value is no longer detected at all. It is therewith ensured that the fill level is safely below the second fill level value after step S102. In the event that the ink container 48 is already empty, for example given servicing, step S102 can be skipped. Given other measurement measures, such as an ultrasonic fill level measurement, the ink pump 42, 43 can also be stopped upon reaching the second fill level value.

In step S104, the pump 42 is activated so that ink is pumped from the ink reservoir 44 into the ink container 48.

In step S106, the time required to pump the ink into the ink container 48 until the first fill level value is reached is detected with the aid of the control unit 40. If using the second signal emitter 54, the second (lower) fill level value is detected in advance of the first (higher) fill level value. The control unit 40 detects the time of the activation of the ink pump 42 as of reaching the second fill level value, until the first fill level value is reached. The time is thus determined that is necessary in order to fill the predetermined volume between the second fill level value and the first fill level value. If the second signal emitter 54 remains unused or is not present, the second fill level value is zero.

In step S108, the flow rate, i.e. the volumetric flow, through the filter unit 41 is determined with the aid of the control unit 40, based on the determined time and the predetermined volume.

In step S110, the determined volumetric flow is subsequently compared with a preset, stored volumetric flow limit value, with the aid of the control unit 40. In step S112, the state of the filter unit 41 is then determined with the aid of the control unit 40. If the result of the comparison of the determined volumetric flow value with the preset, stored volumetric flow limit value is that the determined volumetric flow value does not fall below the volumetric flow limit value, the volumetric flow through the filter unit 41 is appropriate, and it can be assumed from this that the filter unit 41 is not fouled, or is only slightly fouled. However, if the determined volumetric flow value is equal to or less than the preset, stored volumetric flow limit value, the filter is at least significantly fouled. The preset, stored volumetric flow limit value is thereby chosen so that the printing device 10 can still continue to be safely operated. The volumetric flow limit value can in particular be chosen so that the printing device 10 can still continue to be safely operated at least for a predetermined number of operating hours, so that sufficient time remains in order to perform an orderly exchange of the filter of the filter unit 41, or to plan a service operation by a service technician to exchange the filter. The workflow is then ended in step S114.

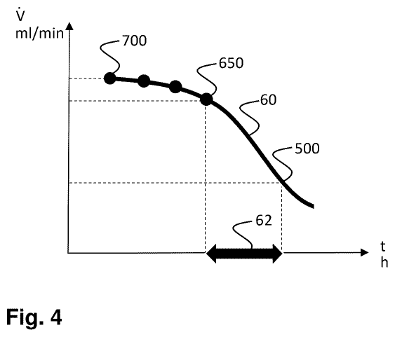

FIG. 4 shows a diagram in which is presented an example of a curve 60 of the volumetric flow through the filter unit 41 depending on the operating time of the printing device 10. The time t indicates the operating hours of the printing device 10. The volumetric flow is indicated in milliliters per minute. Given a new, uncontaminated filter of the filter unit 41, the volumetric flow is 700 milliliters per minute. The volumetric flow through the filter unit 41 decreases with increasing fouling of the filter unit 41. As of a volumetric flow of 650 milliliters per minute, a relevant fouling is established. The preset, stored volumetric flow limit value in this exemplary embodiment is 650 milliliters per minute. Upon reaching or falling below this volumetric flow limit value, a service order to exchange the filter of the filter unit 41 is automatically generated, and/or an information regarding fouling of the filter of the filter unit 41 is output to an operator of the printing device 10. This takes place before a failure of the printing system 10 occurs. A failure of the printing system 10 due to insufficient ink supply is impending as of a volumetric flow of 500 milliliters per minute. Thus, in the time period 62 there is sufficient time in order to change the filter of the filter unit 41.

It is advantageous to determine the flow rate, i.e. the volumetric flow, of the ink pump 42 at intervals of multiple days, and to use the determined volumetric flow as an indicator of the state of the filter of the filter unit 41.

The invention is based on the general realization that the state of the filter of the filter unit 41 has a strong influence on the delivery capacity of the ink pump 42, so that the delivery capacity of the ink pump 42 can be used as an indicator of the degree of fouling of the filter of the filter unit 41.

A planned filter change can be implemented via the invention. The change can then in particular be planned when the printer is not in operation. All filters that have the indication of a blockage, and no other non-fouled filters, can then be changed at the correct point in time. The downtimes of the printing device 10 can thereby be reduced.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general-purpose computer.

For the purposes of this discussion, the terms “processing circuitry” and “control unit” shall be understood to be circuit(s) or processor(s), or a combination thereof. A circuit includes an analog circuit, a digital circuit, data processing circuit, other structural electronic hardware, or a combination thereof. A processor includes a microprocessor, a digital signal processor (DSP), central processor (CPU), application-specific instruction set processor (ASIP), graphics and/or image processor, multi-core processor, or other hardware processor. The processor may be “hard-coded” with instructions to perform corresponding function(s) according to aspects described herein. Alternatively, the processor may access an internal and/or external memory to retrieve instructions stored in the memory, which when executed by the processor, perform the corresponding function(s) associated with the processor, and/or one or more functions and/or operations related to the operation of a component having the processor included therein.

In one or more of the exemplary embodiments described herein, the memory is any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

### REFERENCE LIST

10 printing device
12 recording medium
16, 18,
20, 22,
24 print bar
26 print head
28 print image
30 arrangement to determine a state of a filter unit
34 print group
36 print nozzle
38 column
40 control unit
41 filter unit
42 ink pump
44 ink reservoir
46 ink line
48 ink container
50 print bar ink line
52 first signal emitter
54 second signal emitter
60 graph
62 exchange time period
T1 transport direction

1. A method for determining a state of a filter unit in an ink circuit of a printer, the method comprising:
pumping ink from an ink reservoir, through the filter unit, into an ink container based on an initial fill level of said ink container,
detecting at least one first fill level value in the ink container with a sensor unit, wherein the initial fill level is below the first fill level value,
pumping ink with an ink pump into the ink container until the first fill level value is reached, so that at least a predetermined volume between the initial fill level and the first fill level value is filled,
detecting a time of the activated ink pump until the first fill level value is reached,
determining a volumetric flow through the filter unit based on the predetermined volume and the detected time, and
comparing the determined volumetric flow with a volumetric flow limit value,
wherein a filter state information is generated upon reaching or falling below the volumetric flow limit value.

2. The method according to claim 1, wherein the ink container is empty at the initial fill level.

3. The method according to claim 1, wherein the sensor unit detects a second fill level value, and the initial fill level corresponds to the second fill level value.

4. The method according to claim 1, wherein the initial fill level of the ink container is achieved by pumping ink from the ink container with the ink pump or an additional ink pump.

5. The method according to claim 1, wherein the ink pump is activated with a control voltage so that a pump rotor is preloaded at rest and, given a sudden increase in the control voltage, the pump rotor drives the ink pump with a nominal rotation speed, and ink is thereby pumped at a constant delivery rate with the aid of the ink pump.

6. The method according to claim 1, wherein the ink pump is an electrically driven gear pump.

7. The method according to claim 1, wherein the method is implemented in at least one of a printing pause, every 1 to 2 days, or every 24 to 48 operating hours.

8. The method according to claim 1, wherein a value in a range of from 60% to 80% of the volumetric flow with a new filter is preset as a limit value.

9. The method according to claim 1, wherein a warning notification is output upon reaching or falling below the limit value.

10. A device for determining a state of a filter unit in an ink circuit of a printer, the device comprising:
at least one ink pump to pump ink,
an ink container to provide ink for print heads of the printer,
an ink reservoir to provide ink,
at least one filter unit to filter the ink,
at least one sensor unit configured to detect at least one first fill level value in the ink container, wherein an initial fill level is below the first fill level value, and
a control unit operatively connected to the at least one ink pump and the at least one sensor unit and configured to:
activate the ink pump to pump ink from the ink reservoir, through the filter unit, into the ink container, starting from the initial fill level of said ink container, until the first fill level value is reached, so that at least a predetermined volume between the initial fill level and the first fill level value is pumped through the filter unit, detect at least a time of the activated ink pump until the first fill level value is reached,
determine a volumetric flow through the filter unit, based on the predetermined volume and the detected time,
compare the determined volumetric flow with a volumetric flow limit value, and
generate a filter state information at least upon reaching or falling below the volumetric flow limit value.

11. The device according to claim 10, wherein the ink container is empty at the initial fill level.

12. The device according to claim 10, wherein the sensor unit detects a second fill level value, and the initial fill level corresponds to the second fill level value.

13. The device according to claim 10, wherein the initial fill level of the ink container is achieved by pumping ink from the ink container with the ink pump or an additional ink pump.

14. The device according to claim 10, wherein the ink pump is activated with a control voltage so that a pump rotor is preloaded at rest and, given a sudden increase in the control voltage, the pump rotor drives the ink pump with a nominal rotation speed, and ink is thereby pumped at a constant delivery rate with the aid of the ink pump.

15. The device according to claim 10, wherein the ink pump is an electrically driven gear pump.

16. The device according to claim 10, wherein a value in a range of from 60% to 80% of the volumetric flow with a new filter is preset as a limit value.

17. The device according to claim 10, wherein a warning notification is output upon reaching or falling below the limit value.
